(19) United States
(12) Patent Application Publication
(10) Pub. No.: US 2015/0331976 A1
(43) Pub. Date: Nov. 19, 2015

(54) FORECASTING OIL PRODUCTION FOR MULTIPLY-FRACTURED HORIZONTAL WELLS

(71) Applicant: Schlumberger Technology Corporation, Sugar Land, TX (US)

(72) Inventor: Qingfeng Tao, Katy, TX (US)

(21) Appl. No.: 14/575,442

(22) Filed: Dec. 18, 2014

Related U.S. Application Data
(60) Provisional application No. 61/993,852, filed on May 15, 2014.

(51) Int. Cl. G06F 17/50; G06F 17/10

(52) U.S. Cl. CPC G06F 17/5009; G06F 17/10

(57) ABSTRACT

Methods, computing systems, and computer-readable media for forecasting oil recovery from a well. The method includes obtaining bottom-hole pressures, production rates, and a reservoir pressure for the well, and calculating pressure normalized rates based thereon. The method also includes forecasting a forecasted bottom-hole pressure for a first material balance time, based on the plurality of bottom-hole pressures, and forecasting a forecasted pressure normalized rate for the first material balance time based on the pressure normalized rates. The method further includes calculating a forecasted production rate for the first material balance time, based on the production rates, and determining a first forecasted cumulative production at the first material balance time based on the forecasted production rate, bottom-hole pressure, and pressure normalized rate, and converting the first material balance time to a first real time based at least partially on the forecasted cumulative production and production rate.

### CROSS-REFERENCE TO RELATED APPLICATION

This application claims priority to U.S. Provisional Patent Application having Ser. No. 61/993,852, filed on May 15, 2014. The entirety of this priority provisional patent application is incorporated by reference herein.

### BACKGROUND

In oil and gas field development, oil and gas production and estimated ultimate recovery (EUR) may be forecasted. Generally, there are three types of production forecast methods: Decline Curve Analysis (DCA), Rate Transient Analysis (RTA), and numerical reservoir modeling and simulation methods. DCA methods rely on historical production data, and function parameters are fitted by matching the historical production data. Thereafter, the future production is forecasted by using the fitted function.

Both the RTA methods and numerical modeling and simulation methods require large amounts of input data, e.g., geological data, reservoir data, pressure, volume, and time (PVT) data, production data, etc. Further, these methods can take longer to history-match the reservoir model and forecast production as compared to the DCA methods. In some cases, certain pieces of input data, which may be required to support RTA and/or numerical modeling and simulation methods, may be not be available. Accordingly, some input data may be assumed or estimated, which may add uncertainty to the model and, thus, the forecasted results. In the presence of complete input data, the RTA and numerical modeling and simulation methods generally provide more accurate results than the analytical methods; however, because complete input data sets are generally not available, DCA methods are generally used to forecast the oil and gas production.

Recently, multiply-fractured, horizontal wells have been used in the development of shale gas or shale oil. Traditional DCA methods, however, generally do not provide a good fit for the oil and gas production from such multiply-fractured, horizontal wells in the development of shale gas or shale oil.

### SUMMARY

Embodiments of the present disclosure include methods, computing systems, and computer-readable media for forecasting oil recovery from a well. For example, an embodiment of the method provided herein, the method includes obtaining a plurality of bottom-hole pressures, a plurality of production rates, and a reservoir pressure for the well, and calculating a plurality of pressure normalized rates based at least partially on the plurality of bottom-hole pressures, the plurality of production rates, and the reservoir pressure. The method also includes forecasting a forecasted bottom-hole pressure for a first material balance time, based on the plurality of bottom-hole pressures, and forecasting a forecasted pressure normalized rate for the first material balance time based at least partially on the plurality of pressure normalized rates. The method further includes calculating a forecasted production rate for the first material balance time, based on the plurality of production rates, and determining a first forecasted cumulative production at the first material balance time based on the forecasted production rate, the forecasted bottom-hole pressure, and the forecasted pressure normalized rate. The method further includes converting, using a processor, the first material balance time to a first real time based at least partially on the forecasted cumulative production and the forecasted production rate.

The foregoing summary is presented merely to introduce some of the aspects of the disclosure, which are described in greater detail below. Accordingly, the present summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a simplified, conceptual side view of a well, according to an embodiment.

FIG. 2 illustrates a flowchart of a method for forecasting oil recovery from a well, according to an embodiment.

FIG. 3 illustrates a plot of historical production rates and bottom-hole pressures for a well, according to an embodiment.

FIG. 4 illustrates a plot of pressure normalized rate versus material balance time, according to an embodiment.

FIG. 5 illustrates a plot of bottom-hole pressure versus material balance time, according to an embodiment.

FIG. 6 illustrates a plot of production rate versus material balance time, according to an embodiment.

FIG. 7 illustrates a plot of cumulative production versus material balance time, according to an embodiment.

FIG. 8-1 illustrates a plot of production rates and bottom-hole pressures versus real time, according to an embodiment.

FIG. 8-2 illustrates a plot of cumulative production versus real time, according to an embodiment.

FIG. 9 illustrates a flowchart of a method for converting from a material balance time domain to a real time domain, according to an embodiment.

FIG. 10 illustrates a plot of production rates, showing a comparison of forecasted production rates for three models, according to an embodiment.

FIG. 11 illustrates a plot for cumulative production, showing a comparison of forecasted cumulative production for three models, according to an embodiment.

FIG. 12 illustrates a schematic view of a processor system, according to an embodiment.

### DETAILED DESCRIPTION

The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure.

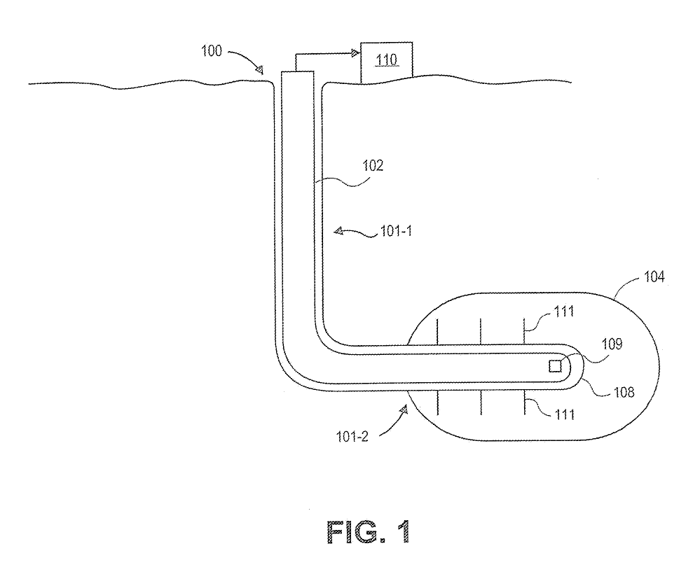

FIG. 1 illustrates a simplified, conceptual side view of a well 100 with a production assembly 102 deployed therein, according to an embodiment. The well 100 may be deviated, and may thus include a vertical section 101-1 and a horizontal section 101-2. In other embodiments, the well 100 may be horizontal, vertical, or may have any other, e.g., more complex, trajectory.

The production assembly 102 may include a casing and/or other oilfield tubulars such as production tubing, liners, etc., as well as tools such as packers, hangers, sleeves, etc. Components of the production assembly 102 may traverse one or more reservoirs 104. Further, a “bottom-hole” pressure, which may be representative of the pressure proximal to the distal end 108 of the well 100 or another relevant location (e.g., at the reservoir(s) 104) may be directly measured, e.g., using a gauge 109, or calculated from other measurements, such as well-head pressure. Bottom-hole pressure may be maintained at a certain, minimum level, e.g., in artificial lift situations.

The well 100 may also include one or more fractures 111, as shown, extending into the surrounding formation, e.g., at the reservoir 104 location. The fractures 111 may be hydraulic fractures, created using hydraulic fracturing techniques. The fractures 111 may have proppant disposed therein, and may form a preferential flowpath for fluid, e.g., hydrocarbons, to flow from the reservoir 104 into the production assembly 102. These produced fluids may be received into the production assembly 102 and carried to equipment 110 at the topside 112 (e.g., the surface of the Earth) of the well 100. The fluid flow rate, amount of flow, etc. may be measured and/or calculated using such equipment 110.

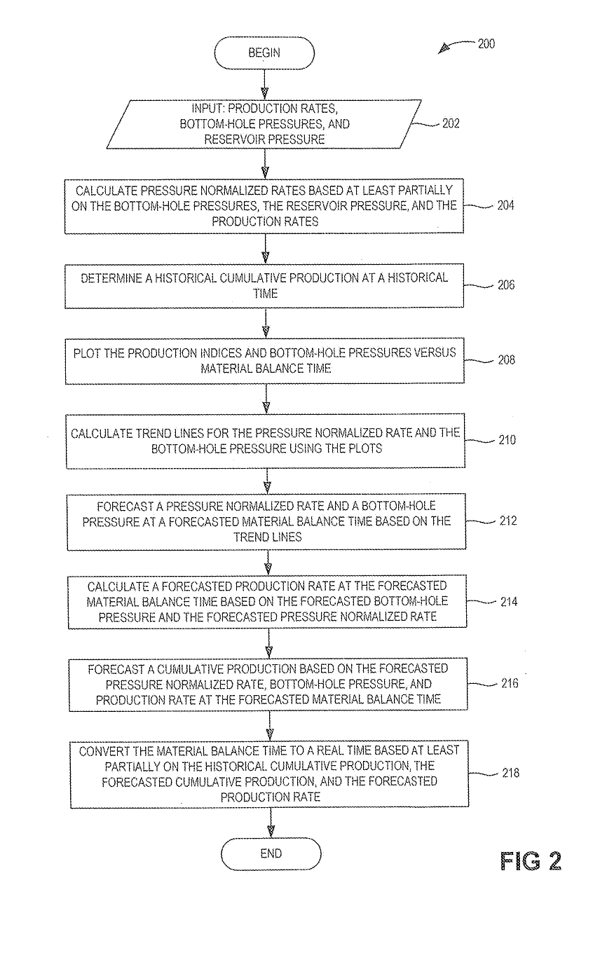

FIG. 2 illustrates a flowchart of a method 200 for forecasting production from a well, according to an embodiment. The method 200 may include receiving, as inputs at 202, a plurality of bottom-hole pressures, a reservoir pressure, and a plurality of production rates. For example, a bottom-hole pressure and a production rate may be received, determined, or otherwise obtained for each of a plurality of data points at different times. Further, the data points, and thus the bottom-hole pressures and production rates, may be associated, e.g., in a table or another data structure, with the times at which the one or more measurements that led to the bottom-hole pressures and production rates were taken. A time at which a measurement is taken may be referred to as a “historical” time and, by extension, data points, bottom-hole pressures, and production rates recorded based on the measurements at historical times may also be referred to as “historical.” It will be appreciated, however, that “historical” is not intended to refer to any particular length of time in the past.

In some cases, the cumulative production amount may be directly measured, and the production rate may be calculated over a period of time based on the production amount measured. In other embodiments, the production rate may be directly measured. The reservoir pressure may be obtained by a downhole gauge or a pressure transient test, e.g., a diagnostic fracture injection test (DFIT), and may be defined generally as the pressure of the fluid in the rock containing the reservoir.

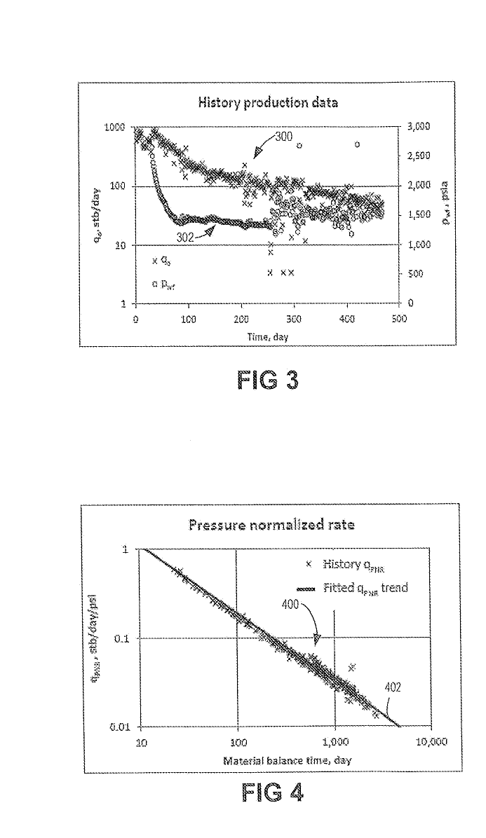

FIG. 3 illustrates a plot of production rates 300 and bottom-hole pressures 302 as a function of time. As shown, for example, the production rates 300 may generally correlate with the bottom-hole pressures 302.

Referring again to FIG. 2, the method 200 may include calculating a plurality of pressure normalized rates based at least partially on the bottom-hole pressures, the production rates, and the reservoir pressure, as at 204. The pressure normalized rates, qpNR, at a time t may be calculated using equation (1), as follows:

$${q}_{PNR}^{t} = \frac{{q}_{o}^{t}}{{p}_{i} - {p}_{wf}^{t}} \qquad ( 1 )$$

where qₒ^{t} is the oil production rate, qₒ, at time t, pᵢ is the initial reservoir pressure, and p_{wf}^{t} is the bottom-hole pressure, p_{wf}, at time t.

A pressure normalized rate q_{PNR}^{t} may be calculated for one, some, or all of the data points for which bottom-hole pressure p_{wf}^{t} and oil production rate qₒ^{t} data are obtained. Further, the pressure normalized rate q_{PNR}^{t} may be calculated at certain time intervals during the production of a well. For example, the pressure normalized rate q_{PNR}^{t} may be calculated one or more times every minute, hour, day, month, year, etc. The oil production rate g^{t}, bottom-hole pressure p_{wf}^{t}, and thus the pressure normalized rate q_{PNR}^{t} may be variable, but the initial reservoir pressure p, can be constant for a specified well, as it may be a function of the geological properties of the reservoir rock.

The method 200 may also include determining a historical cumulative oil production at a historical time, as at 206. This determination may include performing a calculation using the oil production rates and the duration from initiation of production (or another point) to the historical time. In another embodiment, the cumulative oil production may be directly measured. The historical cumulative oil production may be employed as a baseline for future forecasting, as will be described in greater detail below.

The method 200 may then proceed to plotting the bottom-hole pressures and pressure normalized rates versus material balance time, for example, on a logarithmic scale or a log-log plot, as at 208. Material balance time t_{mb} may be defined according to equation (2) as:

$${t}_{mb} = \frac{{Q}_{o}^{t}}{{q}_{o}^{t}} \qquad ( 2 )$$

where Qₒ^{t} is the cumulative oil production up to time t and, as noted above, qₒ^{t} is the oil production rate.

FIG. 4 illustrates a log-log plot 400 of the pressure normalized rate versus material balance time in an illustrative example, e.g., using the data shown in FIG. 3. FIG. 5 illustrates a plot 500 of bottom-hole pressure versus material balance time on a logarithmic scale.

The method 200 may include calculating trend lines for the pressure normalized rate and the bottom-hole pressure as functions of material balance time, as at 210. The trend lines may be calculated using any suitable regression or other statistical technique. The trend lines for the pressure normalized rate and bottom-hole pressure are indicated at 402 and 502 in FIGS. 4 and 5, respectively.

In an embodiment, the bottom-hole pressure may not continue reducing with time to zero, e.g., based on production conditions. A minimum bottom-hole pressure may thus be set according to such production conditions. For example, a well may be produced using artificial lift, and thus the minimum bottom-hole pressure may be larger than the oil and water static pressure from the artificial pump to the reservoir. In a specific example, the minimum bottom-hole pressure may be 800 psia (5.52 MPa), although any other suitable pressure minimum may be employed according to a variety of factors, as will be appreciated by one of skill in the art.

The bottom-hole pressure may decrease according to the trend line 502 until reaching the minimum, and then stay generally constant. The pressure normalized rate may continue to decrease as a function of time according to the trend line 402. As such, the pressure normalized rate and bottom-hole pressure in the domain of material balance time may be forecasted based on their respective trend lines 402, 502, while considering any applicable constraints, such as a minimum bottom-hole pressure.

Thus, as shown, the method 200 may include forecasting the pressure normalized rate and the bottom-hole pressure at a material balance time, as at 212, e.g., by extending the trend line 402, 502 in the plots 400, 500 past the historical material balance times to a certain forecasted material balance time. In particular, the forecasted material balance time may be the historical time plus a material balance time step, or an integer multiple thereof, as will be described in greater detail below.

The method 200 may also include calculating a forecasted oil production rate at a material balance time, based on the forecasted bottom-hole pressure and the forecasted pressure normalized rate, as at 214. By forecasting the pressure normalized rate and the bottom-hole pressure, a forecasted oil production rate qₒ^{t}^{_{mb}} at a material balance time t_{mb} may be calculated by rearranging equation (1) to arrive at equation (3):

qₒ^{t}^{_{mb}}=q_{PNR}^{t}^{_{mb}}×(pᵢ−p_{wf}^{t}^{_{mb}}) (3)

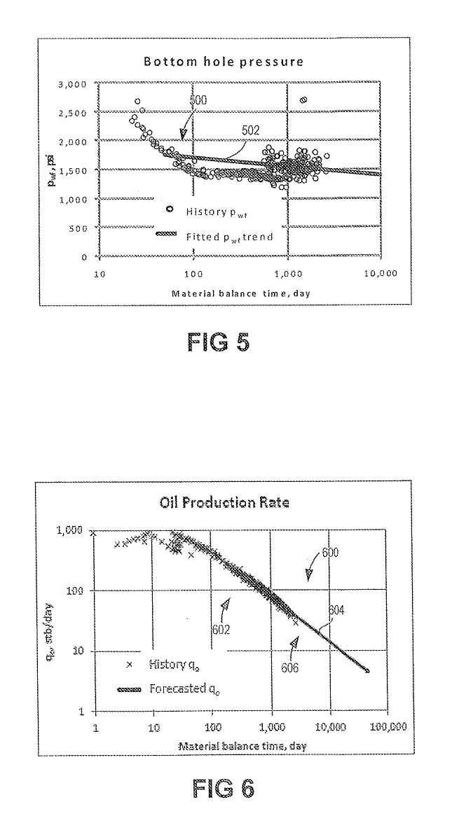

FIG. 6 illustrates a plot 600 of the oil production rate, calculated using equation (3), for a specific example. In particular, the plot 600 includes historical production rates 602 and forecasted oil production rates along line 604. The forecasted production rates along line 604 may be calculated using the forecasted bottom-hole pressures along the trend line 402 and pressure normalized rates along the trend line 502 at corresponding material balance times.

Based on the forecasted oil production rate, bottom-hole pressure, and pressure normalized rate, the cumulative oil production may be forecasted at any material balance time, as at 216. In particular, in an embodiment, equations (2) and (3) may be combined to calculate the cumulative oil production at a material balance time. This relationship may be provided as equation (4), as follows:

Qₒ^{t}^{_{mb}}=t_{mb}×q_{PNR}^{t}^{_{mb}}×(pᵢ−p_{wf}^{t}^{_{mb}}) (4)

Equation (4) may provide a valid forecast when the cumulative oil production increases from the cumulative oil production Qₒ^{hist} calculated at the last historical time t^{hist}.

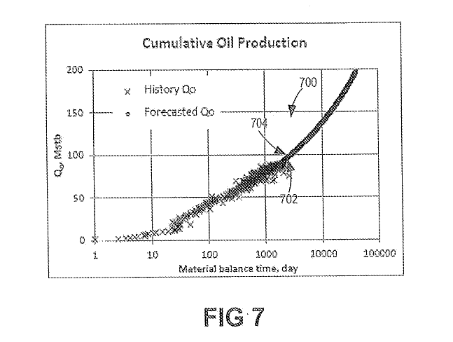

FIG. 7 illustrates a plot 700 of cumulative oil production, which may be calculated using equation (4) and based on the data shown in plots 500, 600, according to an example. However, as noted above, the cumulative oil production amounts shown in the plot 600 are in the material balance time domain (e.g., as a function of material balance time), rather than the real time domain. That is, since the cumulative oil production is calculated using the pressure normalized rate and the bottom-hole pressure trend lines 402, 502, which are calculated in the material balance time domain, the calculated cumulative production is also associated with material balance time, not real time.

Thus, referring again to FIG. 2, the method 200 may thus also include converting the material balance time to a real time, as at 218. In some embodiments, as shown, this may be performed based at least partially on the historical cumulative oil production (e.g., as determined at 206), the forecasted cumulative oil production (e.g., as forecasted at 216), and the forecasted oil production rate (e.g., as calculated at 214).

For example, the converting at 218 may include defining a material balance time step Δt_{mb}. In the material balance time domain, the material balance time step Δt_{mb} may be constant; however, this may correspond to a changing real time increment as between successive data points, as will be understood from the description below. Generally, field production data is reported on a daily frequency. The production rate generally declines with time. According to the definition of material balance time in equation (2), the real time may be less than the material balance time unless at the first day. Therefore, if the step Δt_{mb} is set as one day, the converted increment of real time may be less than one day, which, since it is less than the frequency of data reporting for the well, may be accurate enough with respect to the actual field test frequency. If the forecasted production does not change, the step Δt_{mb} may be increased. As such, the future cumulative production may be forecasted starting from using a step Δt_{mb} of one day and then increased one or more times, if the forecasted production does not change.

In order to explain the conversion process, a naming convention is employed herein; this naming convention is not to be considered limiting. The real time t^{hist} at the last historical data point may be known, e.g., by recording when the last measurements in time were taken. The material balance time t_{mb}¹ at the first forecasted data point 1 is the first forecasted point where the forecasted cumulative oil production is larger than the total history cumulative oil production. The material balance time t_{mb}⁰ is one step Δt_{mb} before the first forecasted data point 1 (t_{mb}⁰=t_{mb}¹−Δt_{mb}). The “last” historical time t^{hist} may refer to the last measurement in time that will be used to forecast production metrics, although subsequent measurements may have been taken.

Referring again to FIG. 7, as a descriptive example, the last historical cumulative oil production, indicated at 702, Qₒ^{hist} is 88.26853 Mstb. The material balance time step Δt_{mb} may be set to one day. The first forecasted cumulative oil production Qₒ¹, indicated at 704, at the material balance time t_{mb}¹, is 88.27333 Mstb. According to the plot 600 of FIG. 6, the forecasted oil production rate qₒ¹ at the first forecasted data point 1 and forecasted oil production rate qₒ⁰ at one step Δt_{mb} before the first forecasted data point 1, indicated as 606, are 48.668910 stb/day and 48.70905 stb/day, respectively.

Because the material balance time step Δt_{mb} is small, the oil production rate from the last historical data point to the first forecast data point 1 may be considered equal to the average of forecasted oil production rate qₒ¹ and qₒ⁰. Thus, referring again to the definition of t^{mb} established by equation (2), the real time increment between the last historical data point, indicated in FIG. 7 at 702, and the first forecasted data point 1, indicated in FIG. 7 at 704, may be calculated as:

$${t}^{1} - {t}^{hist} = \frac{{Q}_{o}^{1} - {Q}_{o}^{hist}}{( {q}_{o}^{1} + {q}_{o}^{0} ) / 2} \qquad ( 5 )$$

where t¹ is the real time at the first forecasted datapoint, t^{hist} is the real time at the last historical data point. By moving the known real time t^{hist} at the last historical data point to the right side of the equation, the real time t¹ at the first data point is calculated.

As such, the real time from the last historical time to the first forecasted point is calculated. This may be repeated for calculating the real time t² at the second forecasted data point 2, using the calculated time t¹ as the prior time. Thus, equation (5) may be generalized as:

$${t}^{n} - {t}^{n - 1} = \frac{{Q}_{o}^{n} - {Q}_{o}^{n - 1}}{( {q}_{o}^{n} + {q}_{o}^{n - 1} ) / 2} \qquad ( 6 )$$

for the forecasted data points (e.g., n greater than or equal to 1).

In the example of FIG. 7, the time t^{hist} is 467 days. The first forecasted time t¹ may be calculated according to equation (5) (with t^{hist} moved to the right side), using the difference between the last historical cumulative oil production Qₒ^{hist} and the first forecasted cumulative production Qₒ¹ (including, in this example, a conversion factor of 1000 based on the different units between Q and q):

$${t}^{1} = 467 + \frac{88.27333 \times 1000 - 88.26853 \times 1000}{( 48.6891 + 48.70905 ) / 2} = 467.09856 days$$

As will thus be appreciated, the real-time step between t^{hist} and t¹ is 0.09856 days (467.09856−467).

By repeating the above processes, e.g., using equation (6), the real time at each forecast data point may be calculated. For example, the time t² at the second forecasted data point 2 may be determined, using the calculated time at the previous (i.e., first) forecasted data point t¹, as:

$${t}^{2} = 467.09586 + \frac{88.28586 \times 1000 - 88.27333 \times 1000}{( 48.69916 + 4868910 ) / 2} = 467.35596 days$$

As can be appreciated, the real-time step between t¹ and t² is 0.2574 days (467.35596−467.09856), which is different from the real-time step between t^{hist} and t¹ (0.09856 days), while the material balance time step, as noted, remains one day.

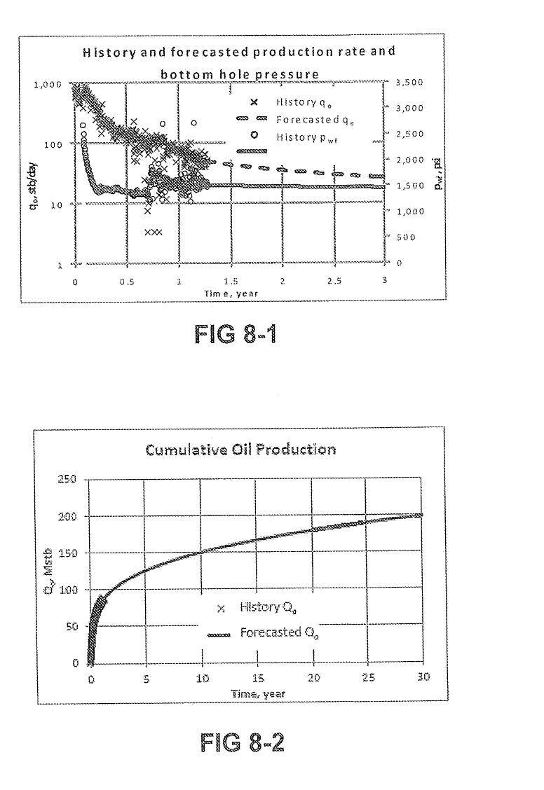

With the conversion from material balance time to real time calculated for the data points, the production rates and bottom-hole pressures may be plotted as a function of real time, as shown in FIG. 8-1. Similarly, the cumulative production may be plotted as a function of real time, as shown in FIG. 8-2. Thus, in this example, the total oil production in 30 years is forecasted to be 198.5 Mstb.

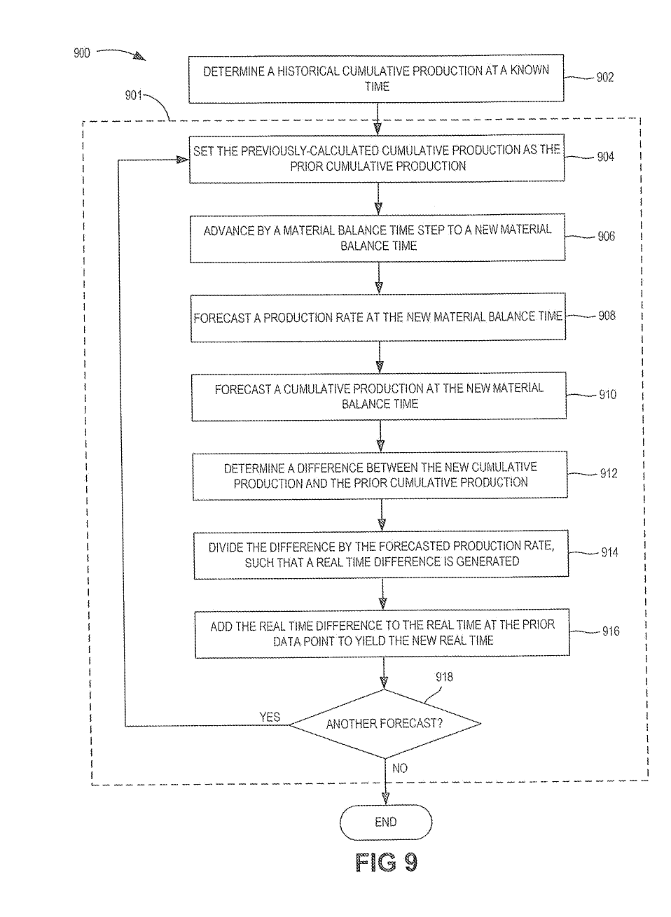

FIG. 9 illustrates a flowchart of a method 900 for converting from the material balance time domain to the real time domain, according to an embodiment, which may be employed, for example, as, or as part of, converting at 218 in method 200. The method 900 may include setting initial conditions, which may include determining a historical cumulative oil production at a historical data point which may be associated with a known real time and a material balance time, as at 902. The method 900 may then enter a loop 903.

In the loop 903, the method 900 may include advancing in the material balance domain by a material balance time step to a new material balance time, as at 904. The material balance time step may be defined a priori and may remain constant in at least some embodiments. The baseline from which the material balance time is advanced, in the first iteration of the loop 903, may be the material balance time of the historical data point. In subsequent iterations (if they occur), the baseline may be the material balance time advanced to in the previous iteration of the loop 903.

The method 900 may include calculating a forecasted production rate at the new material balance time, as at 908, e.g., using a forecasted bottom-hole pressure, a forecasted pressure normalized rate, and equation (3), as explained above. The method 900 may also include forecasting a cumulative oil production at the new material balance time, e.g., using equation (5), as at 910.

The method 900 may proceed to determining a difference between the forecasted cumulative production and the prior cumulative production, as at 912. In the first iteration of the loop 903, the prior cumulative production may be the historical cumulative oil production determined at 902; however, in successive iterations, it is the cumulative oil production that is forecasted at 910 in the previous iteration.

The method 900 may then proceed to dividing the difference between the cumulative oil productions by the forecasted production rate (e.g., at the new material balance time, although a prior forecasted production rate may instead be used), to yield a real time difference, as at 914. The real time difference may then be added to the prior real time to determine a new real time, which corresponds to the new material balance time, as at 916. In the first iteration, the prior real time is the historical time, and in subsequent iterations, the prior real time is what was the new real time in the previous iteration of the loop 903. The method 900 may then include determining whether another forecast is to be considered, as at 918, and, if so, may loop back to the beginning of the loop 903 and advance to the next iteration. Otherwise, the method 900 may end.

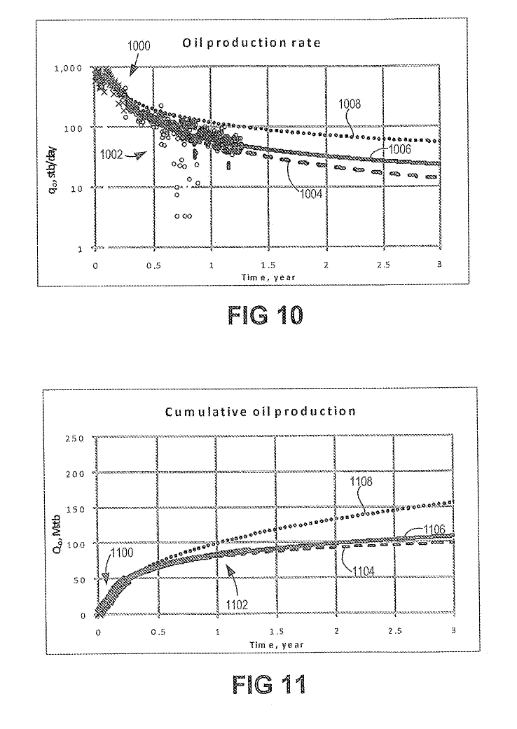

FIGS. 10 and 11 illustrate historical and forecasted oil production rates and cumulative oil production, respectively, according to an embodiment. In particular, the plot of FIG. 10 illustrates historical data points 1000, “future” (i.e., after the historic data points) data points 1002, and forecast lines 1004, 1006, 1008 of three models. The forecast lines 1004, 1006, 1008 are generated using the historical data points 1000, for comparison with the future data points 1002. The forecast line for 1006 represents results generated by an embodiment of the method 200, while the forecast lines 1004 and 1008 represent results generated using two conventional DCA methods.

As shown, the line 1006, generated by the method 200, closely tracks the future data points 1002 provides enhanced accuracy, especially with a relatively small historical dataset. In this illustrative example, the historical data points 1000 are collected over three months, and the future data points 1002 are collected for approximately another year after the historical data points 1000. As can be seen, the line 1004 closely tracks the future data points 1002.

Similarly, in FIG. 11, historical data points 1100 and future data points 1102 for cumulative oil production are plotted, with the future data points 1102 being used to establish three forecast lines 1104, 1106, and 1108. The forecast lines 1104-1108 may then be compared to the future data points 1102. Results generated using an embodiment of the method 200 are indicated by forecast line 1106, while the results generated using two conventional DCA methods are indicated by the lines 1104, 1108. As can again be appreciated, the line 1106 most closely tracks the future data points 1102 based on the historical data points 1100.

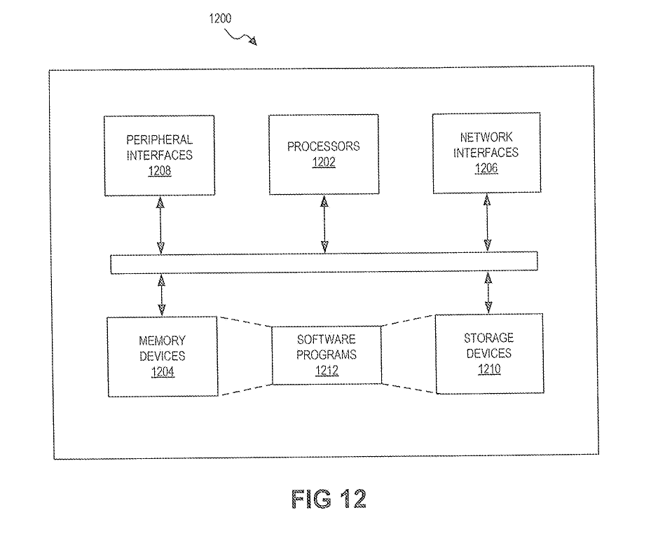

Embodiments of the disclosure may also include one or more systems for implementing one or more embodiments of the method of the present disclosure. FIG. 12 illustrates a schematic view of such a computing or processor system 1200, according to an embodiment. The processor system 1200 may include one or more processors 1202 of varying core (including multi-core) configurations and clock frequencies. The one or more processors 1202 may be operable to execute instructions, apply logic, etc. It will be appreciated that these functions may be provided by multiple processors or multiple cores on a single chip operating in parallel and/or communicably linked together.

The processor system 1200 may also include a memory system, which may be or include one or more memory devices and/or computer-readable media 1204 of varying physical dimensions, accessibility, storage capacities, etc. such as flash drives, hard drives, disks, random access memory, etc., for storing data, such as images, files, and program instructions for execution by the processor 1202. In an embodiment, the computer-readable media 1204 may store instructions that, when executed by the processor 1202, are configured to cause the processor system 1200 to perform operations. For example, execution of such instructions may cause the processor system 1200 to implement one or more portions and/or embodiments of the method(s) described above.

The processor system 1200 may also include one or more network interfaces 1206. The network interfaces 1206 may include any hardware, applications, and/or other software. Accordingly, the network interfaces 1206 may include Ethernet adapters, wireless transceivers, PCI interfaces, and/or serial network components, for communicating over wired or wireless media using protocols, such as Ethernet, wireless Ethernet, etc.

As an example, the processor system 1200 may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

The processor system 1200 may further include one or more peripheral interfaces 1208, for communication with a display screen, projector, keyboards, mice, touchpads, sensors, other types of input and/or output peripherals, and/or the like. In some implementations, the components of processor system 1200 need not be enclosed within a single enclosure or even located in close proximity to one another, but in other implementations, the components and/or others may be provided in a single enclosure. As an example, a system may be a distributed environment, for example, a so-called “cloud” environment where various devices, components, etc. interact for purposes of data storage, communications, computing, etc. As an example, a method may be implemented in a distributed environment (e.g., wholly or in part as a cloud-based service).

As an example, information may be input from a display (e.g., a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

The memory device 1204 may be physically or logically arranged or configured to store data on one or more storage devices 1210. The storage device 1210 may include one or more file systems or databases in any suitable format. The storage device 1210 may also include one or more software programs 1212, which may contain interpretable or executable instructions for performing one or more of the disclosed processes. When requested by the processor 1202, one or more of the software programs 1212, or a portion thereof, may be loaded from the storage devices 1210 to the memory devices 1204 for execution by the processor 1202.

Those skilled in the art will appreciate that the above-described componentry is merely one example of a hardware configuration, as the processor system 1200 may include any type of hardware components, including any necessary accompanying firmware or software, for performing the disclosed implementations. The processor system 1200 may also be implemented in part or in whole by electronic circuit components or processors, such as application-specific integrated circuits (ASICs) or field-programmable gate arrays (FPGAs).

The foregoing description of the present disclosure, along with its associated embodiments and examples, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments.

For example, the same techniques described herein with reference to the processor system 1200 may be used to execute programs according to instructions received from another program or from another processor system altogether. Similarly, commands may be received, executed, and their output returned entirely within the processing and/or memory of the processor system 1200. Accordingly, neither a visual interface command terminal nor any terminal at all is strictly necessary for performing the described embodiments.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques.

What is claimed is:

1. A method for forecasting oil recovery from a well, comprising:
obtaining a plurality of bottom-hole pressures, a plurality of production rates, and a reservoir pressure for the well;
calculating a plurality of pressure normalized rates based at least partially on the plurality of bottom-hole pressures, the plurality of production rates, and the reservoir pressure;
forecasting a forecasted bottom-hole pressure for a first material balance time, based on the plurality of bottom-hole pressures;
forecasting a forecasted pressure normalized rate for the first material balance time based at least partially on the plurality of pressure normalized rates;
calculating a forecasted production rate for the first material balance time, based on the plurality of production rates;
determining a first forecasted cumulative production at the first material balance time based on the forecasted production rate, the forecasted bottom-hole pressure, and the forecasted pressure normalized rate; and
converting, using a processor, the first material balance time to a first real time based at least partially on the forecasted cumulative production and the forecasted production rate.

2. The method of claim 1, further comprising determining a historical cumulative production at a historical real time, wherein converting the first material balance time to the first real time comprises:
determining a difference between the first forecasted cumulative production and the historical cumulative production;
dividing the difference by the forecasted production rate, such that a real time difference is generated; and
adding the real time difference to the historical real time.

3. The method of claim 1, wherein forecasting the forecasted pressure normalized rate comprises:
plotting the plurality of pressure normalized rates versus material balance time in a plot; and
determining a trend line in the plot.

4. The method of claim 3, wherein the plot is a log-log plot.

5. The method of claim 1, wherein forecasting the forecasted bottom-hole pressure comprises:
plotting the plurality of bottom-hole pressures versus material balance time in a plot; and
determining a trend line in the plot.

6. The method of claim 1, wherein forecasting the first forecasted cumulative production comprises:
determining a historical cumulative production at a historical time, wherein the first material balance time is equal to the first historical time in a material balance domain plus a material balance time step;
subtracting the historical cumulative production from the forecasted cumulative production, such that a production difference is generated;
dividing the production difference by the forecasted production rate, such that a first real time change is generated; and
adding the first real time change to the historical time in a real time domain to generate a first real time, wherein the first real time corresponds to the first material balance time.

7. The method of claim 6, further comprising:
forecasting a second forecasted production rate, a second forecast pressure normalized rate, and a second forecasted bottom-hole pressure at a second material balance time, wherein the second material balance time equals the first material balance time plus the material balance time step;
forecasting a second forecasted cumulative production at the second material balance time based on the second forecasted pressure normalized rate, the second forecasted bottom-hole pressure, and the second forecasted production rate;
determining a second real time difference between the first and second material balance times, based on a difference between the first and second forecasted cumulative productions divided by the second forecasted production rate; and
determining a second real time, corresponding to the second material balance time, by adding the second real time difference to the first real time.

8. The method of claim 7, wherein the first and second real time differences are not equal, and the material balance time step is constant.

9. A non-transitory computer-readable medium storing instructions that, when executed by a processor, cause the processor to perform operations, the operations comprising:
obtaining a plurality of bottom-hole pressures, a plurality of production rates, and a reservoir pressure for a well;
calculating a plurality of pressure normalized rates based at least partially on the plurality of bottom-hole pressures, the plurality of production rates, and the reservoir pressure;
forecasting a forecasted bottom-hole pressure for a first material balance time, based on the plurality of bottom-hole pressures;
forecasting a forecasted pressure normalized rate for the first material balance time based at least partially on the plurality of pressure normalized rates;
calculating a forecasted production rate for the first material balance time, based on the plurality of production rates;
determining a first forecasted cumulative production at the first material balance time based on the forecasted production rate, the forecasted bottom-hole pressure, and the forecasted pressure normalized rate; and
converting the first material balance time to a first real time based at least partially on the forecasted cumulative production and the forecasted production rate.

10. The medium of claim 9, wherein the operations further comprise determining a historical cumulative production at a historical real time, wherein converting the first material balance time to the first real time comprises:
determining a difference between the first forecasted cumulative production and the historical cumulative production;
dividing the difference by the forecasted production rate, such that a real time difference is generated; and
adding the real time difference to the historical real time.

11. The medium of claim 9, wherein forecasting the forecasted pressure normalized rate comprises:
plotting the plurality of pressure normalized rates versus material balance time in a plot; and
determining a trend line in the plot.

12. The medium of claim 9, wherein forecasting the forecasted bottom-hole pressure comprises:
plotting the plurality of bottom-hole pressures versus material balance time in a plot; and
determining a trend line in the plot.

13. The medium of claim 9, wherein forecasting the first forecasted cumulative production comprises:
determining a historical cumulative production at a historical time, wherein the first material balance time is equal to the first historical time in a material balance domain plus a material balance time step;
subtracting the historical cumulative production from the forecasted cumulative production, such that a production difference is generated;
dividing the production difference by the forecasted production rate, such that a first real time change is generated; and
adding the first real time change to the historical time in a real time domain to generate a first real time, wherein the first real time corresponds to the first material balance time.

14. The medium of claim 13, wherein the operations further comprise:
forecasting a second forecasted production rate, a second forecast pressure normalized rate, and a second forecasted bottom-hole pressure at a second material balance time, wherein the second material balance time equals the first material balance time plus the material balance time step;
forecasting a second forecasted cumulative production at the second material balance time based on the second forecasted pressure normalized rate, the second forecasted bottom-hole pressure, and the second forecasted production rate;
determining a second real time difference between the first and second material balance times, based on a difference between the first and second forecasted cumulative productions divided by the second forecasted production rate; and
determining a second real time, corresponding to the second material balance time, by adding the second real time difference to the first real time.

15. The medium of claim 14, wherein the first and second real time differences are not equal, and the material balance time step is constant.

16. A computing system, comprising:
one or more processors; and
a memory system comprising one or more non-transitory computer-readable media storing instructions that, when executed by at least one of the one or more processors, cause the computing system to perform operations, the operations comprising:
obtaining a plurality of bottom-hole pressures, a plurality of production rates, and a reservoir pressure for a well;
calculating a plurality of pressure normalized rates based at least partially on the plurality of bottom-hole pressures, the plurality of production rates, and the reservoir pressure;
forecasting a forecasted bottom-hole pressure for a first material balance time, based on the plurality of bottom-hole pressures;
forecasting a forecasted pressure normalized rate for the first material balance time based at least partially on the plurality of pressure normalized rates;
calculating a forecasted production rate for the first material balance time, based on the forecasted pressure normalized rate and forecasted bottom-hole pressure;
determining a first forecasted cumulative production at the first material balance time based on the forecasted production rate, the forecasted bottom-hole pressure, and the forecasted pressure normalized rate; and
converting the first material balance time to a first real time based at least partially on the forecasted cumulative production and the forecasted production rate.

17. The system of claim 16, wherein the operations further comprise determining a historical cumulative production at a historical real time, wherein converting the first material balance time to the first real time comprises:
determining a difference between the first forecasted cumulative production and the historical cumulative production;
dividing the difference by the forecasted production rate, such that a real time difference is generated; and
adding the real time difference to the historical real time.

18. The system of claim 16, wherein forecasting the first forecasted cumulative production comprises:
determining a historical cumulative production at a historical time, wherein the first material balance time is equal to the first historical time in a material balance domain plus a material balance time step;
subtracting the historical cumulative production from the forecasted cumulative production, such that a production difference is generated;
dividing the production difference by the forecasted production rate, such that a first real time change is generated; and
adding the first real time change to the historical time in a real time domain to generate a first real time, wherein the first real time corresponds to the first material balance time.

19. The system of claim 18, wherein the operations further comprise:
forecasting a second forecasted production rate, a second forecast pressure normalized rate, and a second forecasted bottom-hole pressure at a second material balance time, wherein the second material balance time equals the first material balance time plus the material balance time step;
forecasting a second forecasted cumulative production at the second material balance time based on the second forecasted pressure normalized rate, the second forecasted bottom-hole pressure, and the second forecasted production rate;
determining a second real time difference between the first and second material balance times, based on a difference between the first and second forecasted cumulative productions divided by the second forecasted production rate; and
determining a second real time, corresponding to the second material balance time, by adding the second real time difference to the first real time.

20. The system of claim 18, wherein the first and second real time differences are not equal, and the material balance time step is constant.
